(19) United States
(12) Patent Application Publication
(10) Pub. No.: US 2025/0388330 A1
(43) Pub. Date: Dec. 25, 2025

(54) POWER UNIT OF AN UNMANNED AERIAL VEHICLE

(71) Applicant: Oleksandr STEPURA, Kyivska oblast (UA)

(72) Inventors: Oleksandr STEPURA, Kyivska oblast (UA); Volodymyr STEPURA, Kyivska oblast (UA)

(21) Appl. No.: 19/244,328

(22) Filed: Jun. 20, 2025

(30) Foreign Application Priority Data
Jun. 20, 2024 (UA) A 2024 03258

(51) Int. Cl. B64D 27/40; B64U 20/20; B64U 50/11; B64U 50/13

(52) U.S. Cl. CPC B64D 27/40; B64U 20/20; B64U 50/11; B64U 50/13

(57) ABSTRACT

A power unit of an unmanned aerial vehicle (UAV), the power unit includes an internal combustion engine with a propeller and an electrical generator on its output shaft. The engine has a muffler and is coupled to an engine bulkhead via a vibration isolation assembly. A battery and a fuel tank are arranged in a fuselage middle part, and the tank is coupled to the engine via a fuel line. The electrical generator is arranged between the propeller and the engine and is configured to operate in a starter mode. The vibration isolation assembly comprises an engine plate secured to the engine bulkhead and an engine mount coupled to the engine. The plate and mount are coupled between each other with supports equipped with vibration-dampening assemblies coupled to the mount. An arc-shaped bracket is between the engine plate and the engine mount and is secured to two supports and coupled to the mount via an additional vibration-dampening assembly. The engine is coupled to the mount via spacers.

### CROSS-REFERENCE TO RELATED APPLICATION

This application claims priority to Ukrainian Application No. a 2024 03258, filed Jun. 20, 2024, which is hereby incorporated by reference in its entirety.

### FIELD OF THE INVENTION

The claimed invention relates to a field of aviation technologies, and it concerns a powerplant of an unmanned aerial vehicle (UAV), namely, a power unit that creates a minimum level of vibrations in a UAV fuselage and ensures reliable operation during long-duration independent UAV flight.

### BACKGROUND

An arrangement of UAV elements is a key aspect that affects their efficiency and reliability. In particular, one of the main assemblies is a power unit that ensures required traction-altitude and speed characteristics of the UAV.

UAVs are equipped with aircraft engines, and in order to ensure high power and long-duration independent flight, internal combustion engines are used most frequently. Most frequently, the aircraft engine is mounted on one shaft with a propeller in order to ensure optimal transfer of mechanical energy for the UAV movement in the air. Main functions of the UAV engine include providing a traction force, i.e., generating a required force for the movement of the aerial vehicle in the air.

A typical configuration of the UAV power unit implies provision of the aircraft engine having a propeller that is mounted on its output shaft. At the same time, the engine may be equipped with a muffler in order to reduce noise. In order to reduce a vibratory load, the engine is coupled to an engine bulkhead via a vibration-isolating assembly. At the same time, a battery for powering onboard equipment and a fuel tank that is coupled to the engine via a fuel line are usually mounted in the fuselage, preferably, in a middle part thereof. They are mounted in a close proximity to a UAV's center of gravity that is caused by a need in weight balancing.

For example, a patent CN106697303B dated Mar. 17, 2020 discloses a UAV power unit that comprises an engine and its vibration-isolating assembly with an engine bulkhead, the assembly comprises an engine stabilizer plate, an upper support frame, an engine fixed frame, a lower bracket and three shock absorbers, the upper support frame is secured on the plate and connected to a first shock absorber that is also connected to the engine fixed frame, a lower base of the bracket is secured on the plate and has a second shock absorber that is connected to the lower bracket, a third shock absorber is mounted in the lower bracket, two lower bases of the bracket are secured on the plate, thereby connecting to the second shock absorber via a mounting opening, the upper support frame is secured to the plate at one end, and the first shock absorber is secured at another end, the mounting opening connects the engine mounting to the upper support frame via the first shock absorber. A drawback of this solution is that the shock absorbers are flat bushings mounted between the bracket and bolts with which the engine is secured. This configuration has a limited shock absorption, since it is not capable of reliably absorbing vibrations at low loads, thereby affecting reduction of the UAV independent flight duration, as well as these flat bushings are prone to rapid wear, thereby shortening the operation time and requiring frequent replacement.

An application CN117382890A dated Jan. 12, 2024 discloses a power unit, where an engine is coupled to an engine bulkhead via a vibration-isolating assembly, the assembly is a mounting support having one end that is used for connection to the engine bulkhead, while another end is used for connection to a connecting frame of the engine, where an inner side of the connecting frame is provided with several dampening devices in a circumferential direction, the dampening devices are connected to an outer surface of the engine. A drawback of this technical solution is that the structure remains sensitive to frequency fluctuations that may cause resonance phenomena, although the dampening devices connect the outer surface of the engine to the connecting frame. This may result in additional vibration problems, thereby negatively affecting UAV stability and controllability. Besides, a complexity in mounting and servicing these dampening devices may increase maintenance costs and reduce operational effectiveness.

Said power units do not imply any connection between the aircraft engine and an electrical generator for additional use of mechanical energy of the engine to convert it into electrical energy for providing a standalone power supply for all onboard systems, including navigation, communication, control, and other systems, as well as to maintain the operation of additional devices such as cameras, sensors, etc.

Usually, the electrical generators are mounted on an auxiliary shaft in a close proximity to the engine, thereby ensuring effective transfer of the mechanical energy with minimum losses. However, this arrangement often results in problems with dimensions, balancing UAV weight distribution, as well as undesired additional vibrations, thereby affecting its stability and controllability.

Use of a combination of an internal combustion engine and an electrical generator is known from an application WO2024054833A1 dated Mar. 14, 2024 that discloses a micro-hybrid power system that is configured to ensure power supply of at least one UAV rotary engine, the system comprising: an engine that is configured to generate mechanical energy and a generator engine that is directly connected to the engine and configured to generate an alternating current electrical energy using the mechanical energy generated by the engine. A drawback of this arrangement, where the engine is directly connected to the generator engine via a single shared shaft, lies in excessive vibrations that arise as a result of operation of the engine and the generator. These vibrations negatively affect the UAV controllability, structural integrity as well as quality performance of posed tasks. Besides, these vibrations result in deterioration of the power supply and increase of wear of mechanical parts of the system.

An application US2021276723A1 dated Sep. 9, 2021 discloses a UAV power unit, in particular, a fixed-wing UAV, wherein the power unit comprises an engine, a transmission mechanism, an electrical generator, and a battery that is electrically connected to the electrical generator, wherein the transmission mechanism comprises a first drive shaft and a second drive shaft, both of which are transmittingly connected to an output shaft of the engine, the first drive shaft is configured to drive rotation of a power propeller of the UAV, the second drive shaft is configured to drive the electrical generator to generate electricity, the electrical generator is configured to charge the battery that is configured to power a rotary power mechanism of the UAV that drives rotation of rotors of the UAV. A drawback of this technical solution lies in a structural complexity, a presence of the additional shaft increases the UAV weight and results in occurrence of additional vibrations, thereby negatively affecting its aerodynamic characteristics and flight duration. Besides, this arrangement requires additional balancing, since a weight distribution problem arises.

Thus, an important aspect when combining the engine and the generator within a single power unit is their mutual arrangement in such a way that occurring vibrations do not affect the independent flight duration and operational reliability of the UAV.

Therefore, in this field of art, there is a need to develop a UAV power unit that could consider the advantages and drawbacks of the known prior art.

### SUMMARY OF THE INVENTION

Embodiments of the subject invention provide a power unit having a vibration-isolating assembly that combines an internal combustion engine and an electrical generator, as well as that has a high level of reliability and resistance to mechanical stresses.

A technical effect being achieved lies in minimization of dimensions and weight of the UAV, as well as in a signification reduction of a vibrations level that arise during operation of the internal combustion engine and the electrical generator in conditions of a long-duration independent UAV flight. An additional technical effect lies in increase of a heat dissipation area, thereby reducing a risk of the engine overheating, ensuring its continuous cooling and increasing an overall reliability of the aerial vehicle.

Certain embodiments provide a UAV power unit that comprises an internal combustion engine with a propeller that is arranged on an output shaft of the engine and an electrical generator, the engine is equipped with a muffler and coupled to an engine bulkhead via a vibration-isolating assembly, a battery and a fuel tank are arranged in a fuselage middle part, the fuel tank is arranged in a close proximity to a UAV's center of gravity that is coupled to the engine via a fuel line.

This mutual arrangement ensures optimal weight balance and stability of the aerial vehicle during flight, thereby increasing aerodynamic characteristics and reducing a risk of offset of the center of gravity upon a change of a fuel level.

According to the invention, the electrical generator is arranged on the output shaft between the propeller and the internal combustion engine, and it is configured to operate in a starter mode.

This configuration allows to use the electrical generator to start the engine, thereby enhancing reliability and independence of the system. Besides, the presence of the electrical generator and this arrangement thereof ensure to minimize the weight and to prolong the flight duration due to constant power supply of all onboard systems. This significantly reduces a need in additional batteries and back-up power sources that in turn reduces the overall weight of the UAV.

The duration of the independent flight is increased, since the electrical generator ensures a non-interruptible powering of all the systems even in a long flight.

The arrangement of the electrical generator on the shaft that is shared between the engine and the propeller not only reduces the overall weight of the aerial vehicle, but also allows to avoid a problem with balancing, since there is no need of any additional shaft for the electrical generator.

Also, this configuration allows to avoid additional vibrations. Reduction of the vibration level reduces a mechanical wear of the components, thereby reducing a need in a technical maintenance and replacement of parts. This increases the operational reliability of the engine and other UAV systems. Owing to more stable operation of all the components, energy losses are reduced, thereby facilitating more efficient use of fuel and energy and increasing the flight duration.

In a preferred embodiment, the vibration-isolating assembly comprises an engine plate that is secured to the engine bulkhead and an engine mount that is coupled to the engine. The engine plate and the engine mount are coupled to each other with three supports that are equipped with vibration-dampening assemblies that are coupled to the engine mount.

An arc-shaped bracket is arranged between the engine plate and the engine mount, the bracket is secured to two supports and coupled to the engine mount via an additional vibration-dampening assembly. The engine is coupled to the engine mount via spacers.

This configuration ensures dampening of vibrations that are transmitted from the engine and the electrical generator to the fuselage, thereby increasing reliability and service life of the structure, reducing the level of noise and vibrations that results in a positive impact to operation of onboard devices and UAV control convenience.

The vibration-dampening assemblies absorb and dissipate the energy of vibrations, thereby avoiding their transfer to the fuselage. The spacers connecting the engine to the engine mount also help reduce vibration effects due to the rigid attachment of the engine.

According to an exemplary embodiment, the engine plate, the engine mount and the arc-shaped bracket are flat.

According to another exemplary embodiment, the engine plate is perforated.

This configuration ensures minimization of the weight, while preserving the required characteristics of the power unit, including vibration dampening and structural reliability.

According to another possible exemplary embodiment, the engine is secured with at least four spacers that are arranged along an engine mount perimeter.

Also, according to another possible exemplary embodiment, the vibration-dampening assemblies are rubber bushings.

According to another possible exemplary embodiment, one of the supports is configured to secure a fuel pump. This configuration ensures a continuous fuel supply to the engine, thereby increasing reliability and duration of the UAV independent flight due to optimal arrangement fuel system elements.

According to another possible exemplary embodiment, the battery is divided into two parts, where a first part is coupled to a control unit, while a second part is configured to power the electrical generator in the starter mode. This configuration allows to optimize the operation of the aerial vehicle, thereby ensuring a continuous and reliable power supply of the systems, while increasing the duration of the independent flight.

According to another possible exemplary embodiment, the muffler is made as a labyrinth-type muffler and it is secured to the engine in a fuselage front part. This configuration increases a heat dissipation area and reduces a risk of the engine overheating, while ensuring its continuous cooling and increasing an overall reliability of the power unit.

### BRIEF DESCRIPTION OF THE DRAWINGS

In order to provide further understanding of the claimed invention and its advantages, the following description offers an explanation of a possible implementation thereof with reference to the figures of the appended drawings, wherein identical reference numerals denote identical parts, and which illustrate the following:

FIG. 1 illustrates a general view of the power unit,

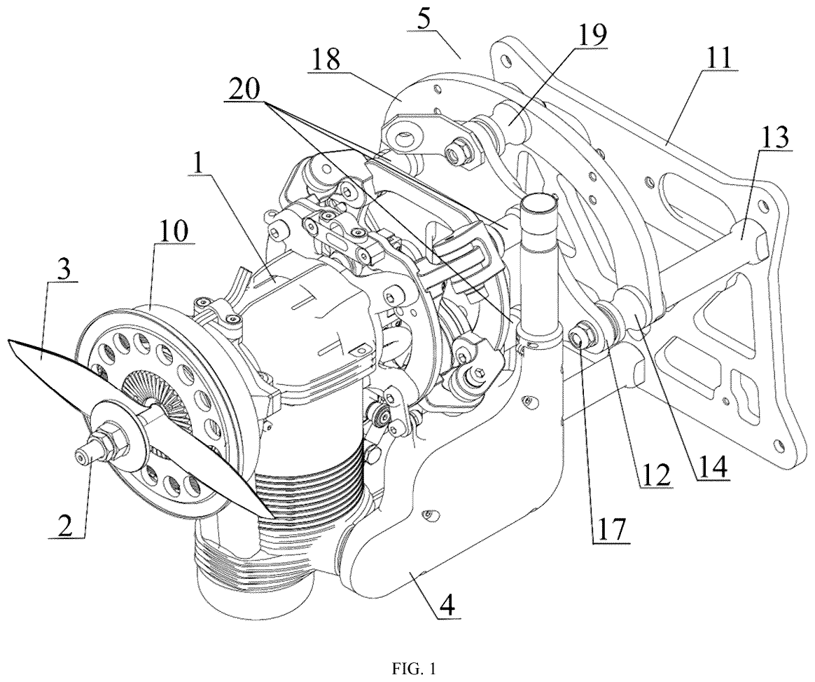

FIG. 2 illustrates a general view of the power unit,

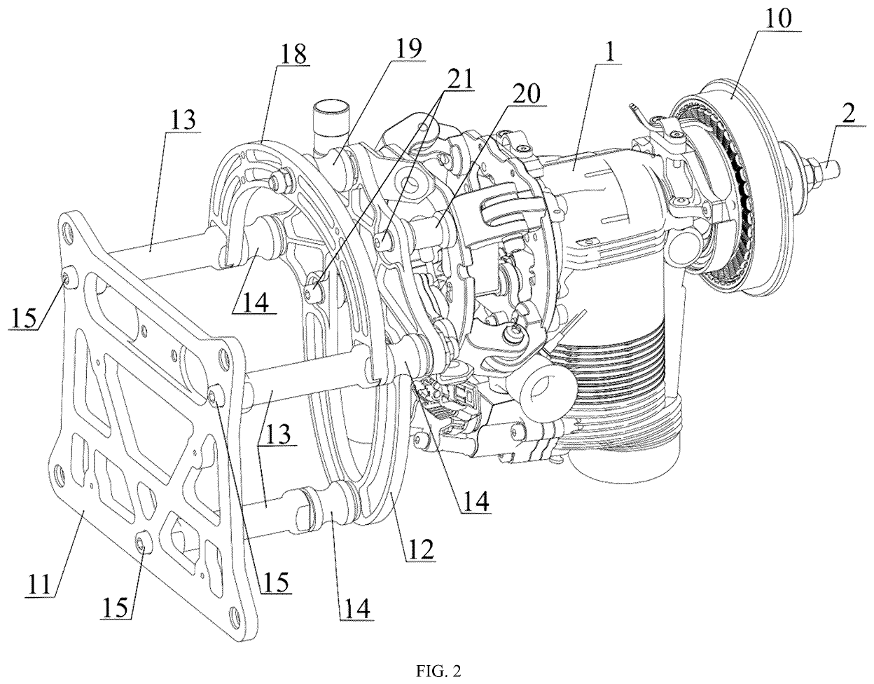

FIG. 3 illustrates a rear view of the power unit,

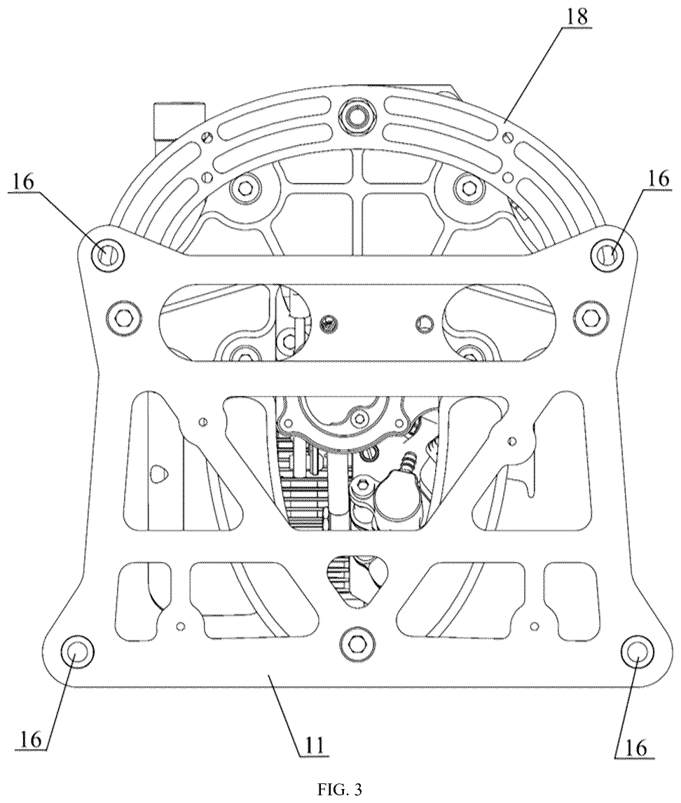

FIG. 4 illustrates a top view of the power unit with the fuel pump secured,

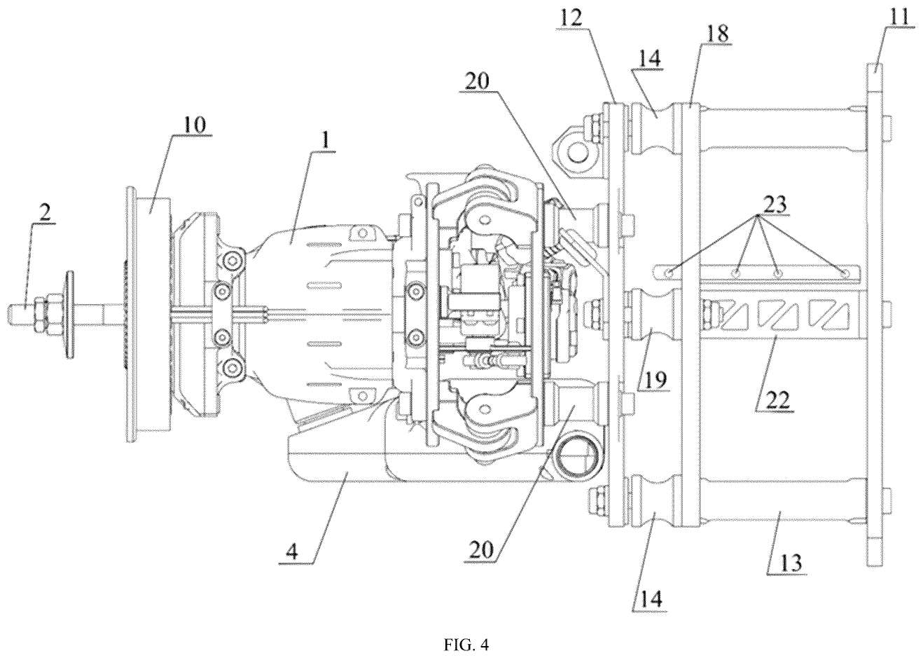

FIG. 5 illustrates a side view of the power unit with the fuel pump secured,

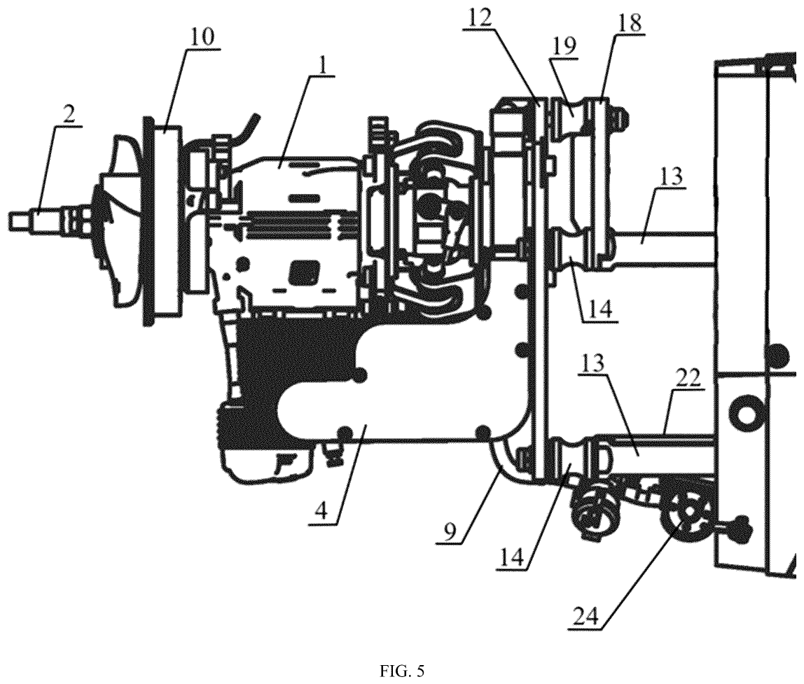

FIG. 6 illustrates the arrangement of the power unit in the UAV.

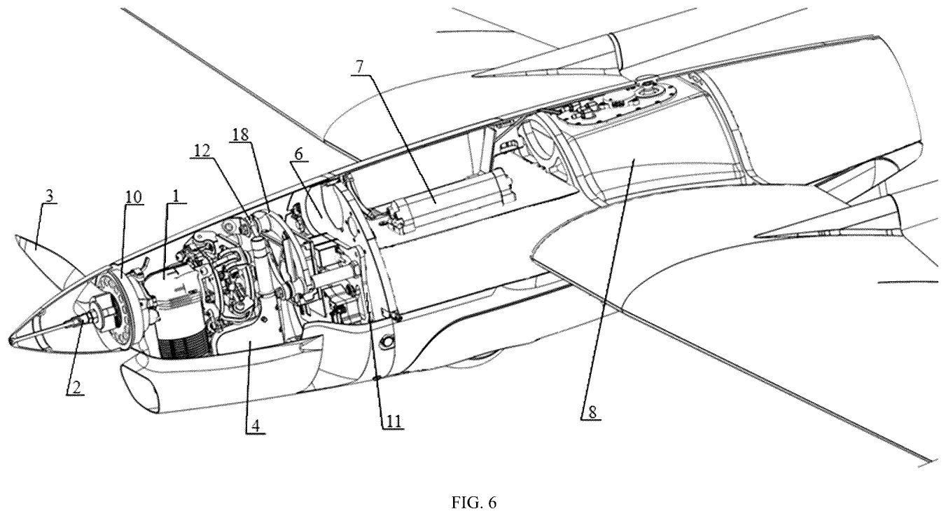

### MAIN DESIGNATIONS

1 the engine,
2 the output shaft,
3 the propeller,
4 the muffler,
5 the vibration-isolating assembly,
6 the engine bulkhead,
7 the battery,
8 the fuel tank,
9 the fuel line,
10 the electrical generator,
11 the engine plate,
12 the engine mount,
13 the supports,
14 the vibration-dampening assemblies,
15 engine plate mounting assemblies,
16 mounting holes,
17 engine mount mounting assemblies,
18 the arc-shaped bracket,
19 the additional vibration-dampening assembly,
20 the spacers,
21 spacers mounting assemblies,
22 a fastener of the fuel pump,
23 holes,
24 the fuel pump.

The illustrative materials that explain the claimed invention and the disclosed specific exemplary embodiments do not limit the claimed scope of rights in any way, rather they only explain the essence of the invention.

### IMPLEMENTATION OF THE INVENTION

A UAV power unit comprises an internal combustion engine (1) with a propeller (3) that is arranged on an output shaft (2) of the engine and an electrical generator (10). The engine (1) is equipped with a muffler (4) and coupled to an engine bulkhead (6) via a vibration-isolating assembly (5). A battery (7) and a fuel tank (8) are arranged in a fuselage middle part, the fuel tank is coupled to the engine (1) via a fuel line (9) and arranged in a close proximity to a UAV's center of gravity.

The electrical generator (10) is arranged on the output shaft (2) between the propeller (3) and the engine (1), and it is electrically connected to the battery (7) in order to maintain and/or to supplement the energy that is accumulated by the battery (7) during operation of the engine (1). Since the electrical generator (10) that is coupled to the engine (1) may charge the battery (7) during the flight, an actual size of the battery (7) may be relatively small.

In this configuration, one of functions of the electrical generator (10) is to ensure a start of the engine (1). During the start, when the engine (1) requires additional current for its initial motion, the electrical generator (10) may operate as an electrical motor. In this arrangement, the electrical generator (10) interacts with the internal combustion engine (1) via the output shaft (2). When the electrical generator (10) briefly operates in motor mode to start the engine (1), the output shaft (2) gains RPMs and simultaneously rotates a rotor of the electrical generator (10) that converts mechanical energy into electrical energy. The obtained electrical energy may be used to power various systems of the aerial vehicle.

The vibration-isolating assembly (5) comprises an engine plate (11) and an engine mount (12), where the engine plate (11) is secured to the engine bulkhead (6), and the engine mount (12) is coupled to the engine (1). The engine plate (11) and the engine mount (12) are coupled between each other with a plurality of supports (13) that are equipped with vibration-dampening assemblies (14) that are coupled to the engine mount (12).

The engine plate (11) is flat, it may have a rectangular shape and it may be perforated. The exemplified three supports (13) are coupled to the engine plate (11) by means of corresponding (here, three) engine plate mounting assemblies (15). The mounting assemblies (15) are formed by passing the supports (13) along through holes of the engine plate (11) and secured, e.g., by means of preferably threaded connections using bolts, screws, studs, pins, etc. In this exemplary embodiment, the engine plate (11) comprises four mounting holes (16) that represent locations where the engine plate (11) is secured to the engine bulkhead (6).

The engine mount (12) is flat, it may have a curved shape having an arc-shaped elongation, and the engine mount (12) may be provided with a blind perforation that lightens the structure, while preserving the required characteristics. The supports (13) are coupled to the engine mount (12) by means of corresponding (here, three) engine mount mounting assemblies (17). The engine mount mounting assemblies (17) are formed by passing the supports (13) with the vibration- dampening assemblies (14) along through holes of the engine mount (12) and secured, e.g., by means of preferably threaded connections using bolts, screws, studs, pins, etc.

The supports (13) are equipped with the vibration dampening assemblies (14) and are coaxial. In this exemplary embodiment, the supports (13) have a cylindrical shape and are made of aluminum, however, they also may have an arbitrary shape and may be made of any suitable material known in the art.

In this embodiment, the vibration dampening assemblies (14) are rubber bushings. Also, the vibration-dampening assemblies (14) may be made of other dampening materials known in the art, e.g., polyurethane, thermoplastic elastomer, silicone, etc., in a form of elements or components that ensure dampening and absorption of vibrations. Use of these materials allows to enhance absorption of vibrations and to reduce their transfer to other parts of the structure.

An arc-shaped bracket (18) is arranged between the engine plate (11) and the engine mount (12), the bracket is flat and may be provided with a blind perforation, thereby ensuring the required rigidity characteristics, while lightening the structure. In this exemplary embodiment, the arc-shaped bracket (18) is secured to two supports (13) and coupled to the engine mount (12) via two vibration-dampening assemblies (14) that are secured on axes of the supports (13). Also, the arc-shaped bracket (18) is coupled to the engine mount (12) via an additional vibration-dampening assembly (19) that is secured on its own axis and arranged equidistantly from the two supports (13).

In this embodiment, the engine (1) is coupled to the engine mount (12) via four spacers (20) that are arranged equidistantly from each other along a perimeter of the engine mount (12). Each distance sleeve (20) is secured on its own axis and connected to the engine mount (12) via a spacers mounting assembly (21). In this embodiment, the spacers (20) are made of aluminum, however, they may be made of any suitable material that is known in the art, thereby ensuring the required strength and resistance to loads during operation of the engine and the electrical generator.

One of the supports (13) comprises a fastener (22) of the fuel pump, the fastener is a perforated bracket that is rigidly secured on the support (13) and is provided with holes (23) for securing a fuel pump (24).

The battery (7) is arranged in a fuselage middle part and may have various shapes and sizes, thereby allowing to use an inner volume of the fuselage in an optimum manner. The battery (7) may be made of lithium-ion elements or other types of elements having a high energy density and a long service life. The battery (7) may be divided into two parts. A first part of the battery (7) ensures power supply to the control, navigation, and flight management systems. This is important for ensuring a continuous operation of electronic components during a long-term independent UAV flight. A second part of the battery (7) is for supplying power to the electrical generator in a starter mode that is used to start the internal combustion engine (1). The division of the battery (7) allows to ensure independent power supply of these two important systems. During the flight, the electrical generator (10) produces current to maintain a sufficient charge level of the battery (7) to ensure operation of all the UAV systems during the long-term flight.

The fuel tank (8) is arranged in the fuselage middle part and may have a parallelepiped shape. The fuel tank (8) may be made of rubber, aluminum alloy or other materials depending on rigidity and weight requirements. It may be equipped with a fuel leakage prevention system and an internal anti-corrosion coating to ensure a safe use of the UAV.

The muffler (4) is preferably made as a labyrinth-type and secured to the engine (1) in a fuselage front part. Inner partitions of the muffler (4) create a complex pathway for exhaust gases. This structure ensures effective reduction of noise that arises during operation of the engine (1) and the electrical generator (10) by repeated reflection and absorption of acoustic waves within the muffler (4). Besides, the labyrinth configuration of the muffler (4) increases a heat dissipation area, thereby facilitating engine (1) cooling and avoiding its overheating.

The subject invention provides a power unit of an unmanned aerial vehicle that can minimize dimensions and weight of the UAV, as well as facilitate a significant reduction of vibration levels that arise during operation of the internal combustion engine and the generator in conditions of a long-duration independent UAV flight.

1. A power unit of an unmanned aerial vehicle (UAV), the power unit comprising: an internal combustion engine; a propeller that is arranged on an output shaft of the engine; and an electrical generator; a muffler coupled to an engine bulkhead via a vibration-isolating assembly; a battery and a fuel tank arranged in a fuselage middle part, the fuel tank arranged in a close proximity to the UAV's center of gravity and coupled to the engine via a fuel line;
wherein the electrical generator is arranged on the output shaft between the propeller and the internal combustion engine, and it is configured to operate in a starter mode,
the vibration-isolating assembly comprises an engine plate that is secured to the engine bulkhead and an engine mount that is coupled to the engine, the engine plate and the engine mount are coupled to each other with a plurality of supports that are equipped with vibration-dampening assemblies that are coupled to the engine mount, and
an arc-shaped bracket is arranged between the engine plate and the engine mount, the bracket is secured to two supports and coupled to the engine mount via an additional vibration- dampening assembly, and the engine is coupled to the engine mount via spacers.

2. The UAV power unit according to claim 1, wherein the engine plate, the engine mount, and the arc-shaped bracket are flat.

3. The UAV power unit according to claim 1, wherein the engine mount is perforated.

4. The UAV power unit according to claim 1, wherein the engine is secured with at least four spacers that are arranged along a perimeter of the engine mount.

5. The UAV power unit according to claim 1, wherein the vibration-dampening assemblies are rubber bushings.

6. The UAV power unit according to claim 1, wherein one of the supports is configured to secure a fuel pump.

7. The UAV power unit according to claim 1, wherein the battery is divided into two parts, where a first part is configured to power control systems, while a second part is configured to power the electrical generator in the starter mode.

8. The UAV power unit according to claim 1, wherein the muffler is made as a labyrinth-type muffler and it is secured to the engine in a fuselage front part.

9. The UAV power unit according to claim 1, wherein the engine plate and engine mount are coupled to each other with three supports.
